(19) United States
(12) Patent Application Publication
(10) Pub. No.: US 2007/0217421 A1
(43) Pub. Date: Sep. 20, 2007

(54) Method and apparatus for controlling packet-transmission, and computer product

(75) Inventors: Hideyuki Kametani, Toyama (JP); Osamu Nakajima, Toyama (JP); Hisato Teguri, Toyama (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/449,995

(22) Filed: Jun. 9, 2006

(30) Foreign Application Priority Data
Mar. 17, 2006 (JP) 2006-075295

(51) Int. Cl. H04L 12/56

(52) U.S. Cl. 370/392; 370/401

(57) ABSTRACT

A transmission control apparatus controls transmission of a packet requesting a name resolution. A determining unit monitors a state of a server that performs the name resolution, and determines whether there is a failure in a first server. A transmission control unit converts, when the determining unit determines that there is a failure in the first server, a destination address set in the packet into a destination address of a second server, and transmits the packet to the second server.

### BACKGROUND OF THE INVENTION

1. Field of the Invention

The present invention relates to a technology for transmitting a packet requesting a name resolution in the Internet environment.

2. Description of the Related Art

In the Internet environment, it is necessary to convert a domain name (host name) to an Internet Protocol (IP) address or vice versa based on the Domain Name System (DNS) when conducting data communication over the Internet. For example, when a client computer terminal attempts to access to contents in a web server by using a domain name, the client computer terminal needs to access to a DNS server via a full-service resolver server to convert the domain name to a corresponding IP address so that the client computer terminal can access to the contents.

If the full-service resolver server is failed and fails to access to the DNS server, it affects to all the Internet accesses over the Internet environment. Therefore, a plurality of the full-service resolver servers has been provided redundantly to increase a fault-tolerance: the servers include a primary server to be primarily used and a secondary server to be used instead of the primary server when the primary server is failed.

Japanese Patent Application Laid-Open No. 2002-9768 discloses a technology for providing a plurality of DNS servers that are redundantly provided and includes a primary DNS server and a secondary DNS server for using the secondary DNS server when the primary DNS server is failed, so that it becomes possible to more effectively use a related network.

However, according to the conventional technology, the client computer terminal does not consider normal or failed state of the full-service resolver server when accessing to the full-service resolver server and always accesses to the primary server at first. Only when the client computer terminal fails to access the primary server, the client computer terminal learns that the primary server is failed, and attempts to access the secondary server. Therefore, it has been required a long time to perform the name resolution.

### SUMMARY OF THE INVENTION

It is an object of the present invention to at least partially solve the problems in the conventional technology.

A transmission control apparatus according to one aspect of the present invention controls transmission of a packet requesting a name resolution. The transmission control apparatus includes a determining unit that monitors a state of a server that performs the name resolution, and determines whether there is a failure in a first server; and a transmission control unit that converts, when the determining unit determines that there is a failure in the first server, a destination address set in the packet into a destination address of a second server, and transmits the packet to the second server.

A method according to another aspect of the present invention is for controlling transmission of a packet requesting a name resolution. The method includes failure determining including monitoring a state of a server that performs the name resolution, and determining whether there is a failure in a first server; and transmission controlling including converting, when it is determined that there is a failure in the first server at the determining, a destination address set in the packet into a destination address of a second server, and transmitting the packet to the second server.

A computer-readable recording medium according to still another aspect of the present invention stores therein a computer program for controlling transmission of a packet requesting a name resolution. The computer program causes a computer to execute failure determining including monitoring a state of a server that performs the name resolution, and determining whether there is a failure in a first server; and transmission controlling including converting, when it is determined that there is a failure in the first server at the determining, a destination address set in the packet into a destination address of a second server, and transmitting the packet to the second server.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the concept of packet transmission according to an embodiment of the present invention;

FIG. 2 is a block diagram of a packet transmission system according to the present embodiment;

FIG. 3 is a detailed functional block diagram of a communication terminal apparatus shown in FIG. 2;

FIG. 4 is an example of the contents of a full-service resolver management table shown in FIG. 3;

FIG. 5 is an example of the contents of a full-service resolver data shown in FIG. 3;

FIG. 6 is another example of the contents of the full-service resolver management table;

FIG. 7 is a flowchart for explaining an operation performed by a full-service resolver monitoring unit shown in FIG. 3;

FIG. 8 is a flowchart for explaining a packet-transmitting operation performed by an IP-address converting unit shown in FIG. 3;

FIG. 9 is a flowchart for explaining a packet-receiving operation performed by the IP-address converting unit; and

FIG. 10 is a block diagram of a computer terminal that realizes the processes according to the present embodiment.

### DETAILED DESCRIPTION OF THE PREFERRED EMBODIMENTS

Exemplary embodiments of the present invention are explained below in detail with reference to the accompanying drawings.

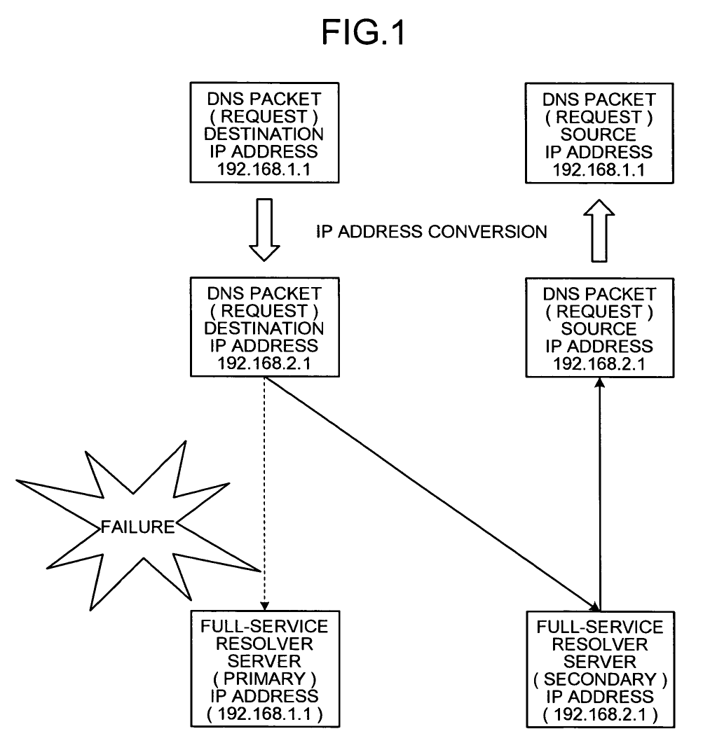

FIG. 1 is a schematic for explaining the concept of packet transmission according to an embodiment of the present invention. When a communication terminal apparatus (not shown) sends a DNS packet used for a name resolution to a server that performs operations corresponding to a full-service resolver server, which is assumed to be provided redundantly, the communication terminal apparatus determines whether a full-service resolver server set as a primary server is failed.

If the primary server is failed, the communication terminal apparatus changes an Internet Protocol address (IP address) set in the DNS packet to be forwarded to the primary server to an IP address of a full-service resolver server set as a secondary server, so that the DNS packet is sent to the secondary server instead of the primary server. Then, upon receiving a DNS response packet from the secondary server, the communication terminal apparatus changes a source IP address in a response to the DNS packet (a DNS response packet) to a source IP address of the primary server.

Thus, when the primary server is failed, the communication terminal apparatus changes the destination IP address of the primary server to a destination IP address of the secondary server in the DNS packet so that the communication terminal apparatus can directly send the DNS packet to the secondary server without attempting to send the packet to the primary server. As a result, an operation time for the name resolution can be reduced.

On the other hand, upon receiving the DNS response packet from the secondary server, the communication terminal apparatus changes the source IP address of the secondary server to a source IP address of the primary server in the DNS response packet so that an application using the DNS packet is not required to perform any special processing, thereby reducing costs.

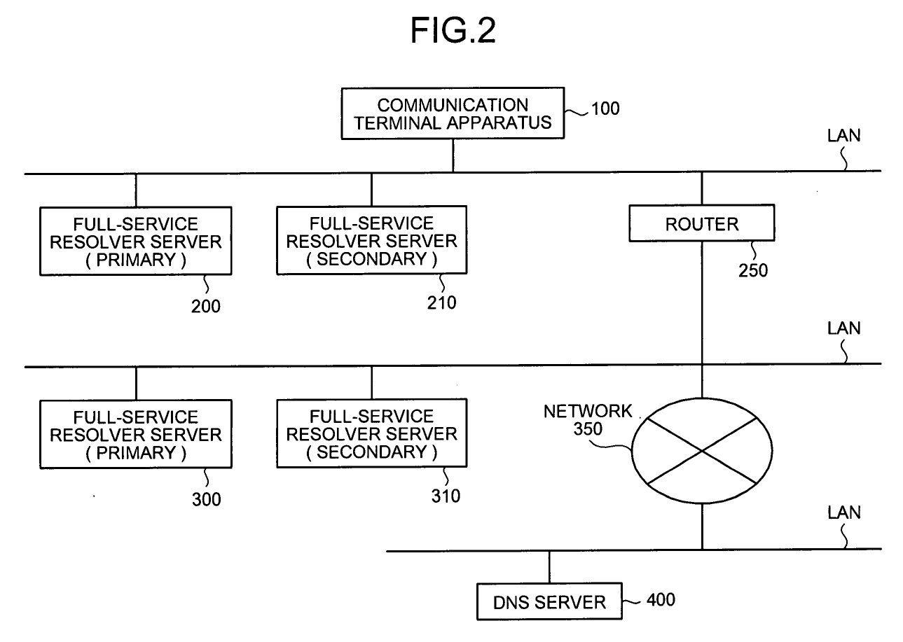

FIG. 2 is a block diagram of a packet transmission system according to the present embodiment. The packet transmission system includes a communication terminal apparatus 100, primary full-service resolver servers 200, 300 (hereinafter, “primary servers 200, 300”), secondary full-service resolver servers 210, 310 (hereinafter, “secondary servers 210, 310”), a router 250, and a DNS server 400. The communication terminal apparatus 100 is connected to the primary server 200, the secondary server 210, and the router 250 via local area network (LAN). The router 250 is further connected to the primary server 300 and the secondary server 310 via LAN and to the DNS server via a network 350.

The communication terminal apparatus 100 sends a DNS packet used for the name resolution to any one of the primary servers 200, 300 or the secondary servers 210, 310. The secondary server 210 is provided redundantly with respect to the primary server 200 while the secondary server 310 is provided redundantly with respect to the primary server 300. Namely, the secondary server 210 has the same functions as those of the primary server 200 while the secondary server 310 has the same functions as those of the primary server 300. Upon receiving the DNS packet sent from the communication terminal apparatus 100, the primary server 200 sends the received DNS packet to the DNS server 400, and then, upon receiving a DNS response packet from the DNS server 400, the primary server 200 sends the received DNS response packet to the communication terminal apparatus 100. The router 250 relays a first network including the communication terminal apparatus 100, the primary server 200, and the secondary server 210 to a second network including the primary server 300, the secondary server 310, and the DNS server 400. Upon receiving the DNS packet from the primary server 200, the DNS server 400 changes a domain name included in the received DNS packet to an IP address corresponding to the domain name to return the DNS response packet including the IP address to the primary server 200. The primary server 300 performs the same functions as those of the primary server 200.

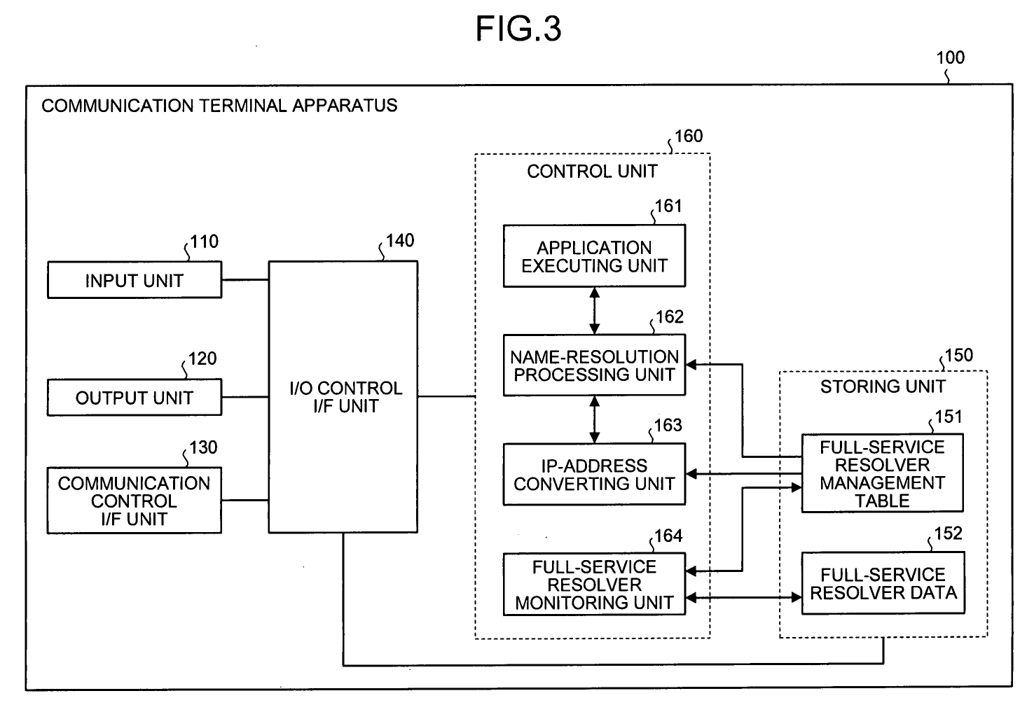

FIG. 3 is a detailed functional block diagram of the communication terminal apparatus 100. The communication terminal apparatus 100 includes an input unit 110, an output unit 120, a communication control interface (I/F) unit 130, an input/output (I/O) control interface (I/F) unit 140, a storing unit 150, and a control unit 160.

The input unit 110 is used for inputting various data and includes, for example, a keyboard, a mouse, a microphone, and the like. The input unit 110 also includes a monitor as a pointing device when used with the mouse. The output unit 120 is used for outputting various data and includes, for example, a monitor (i.e., a display or a touch-panel) a speaker, and the like. The communication control I/F unit 130 controls a communication between the primary servers 200, 300 or the secondary servers 210, 310 and the communication terminal apparatus 100. The I/O control I/F unit 140 controls an input/output of data performed by the input unit 110, the output unit 120, or the communication control I/F unit 130. The storing unit 150 stores data and programs necessary for various operations performed by the control unit 160. More specifically, the storing unit 150 includes a full-service resolver management table 151 and full-service resolver data 152 in relation to the present invention.

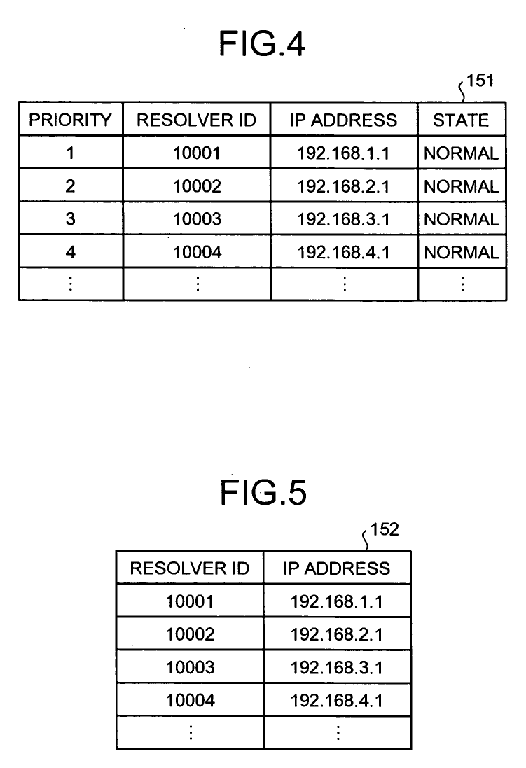

FIG. 4 is an example of the contents of the full-service resolver management table 151. The full-service resolver management table 151 includes a priority order, resolver identification (ID) data, IP addresses, and state information. The priority order indicates an order in which the full-service resolver servers are to be selected to receive the DNS packet from the communication terminal apparatus 100. Numeral 1 corresponds to the highest priority and the priority decreases as the numeral decreases. For example, in FIG. 4, a full-service resolver server with a resolver ID 10001 is on the highest priority to receive the DNS packet unless it is not failed. If the full-service resolver server on the highest priority is failed, a full-service resolver server with a resolver ID 10002, which is on the second highest priority, is selected to receive the DNS packet.

The resolver ID data is information to identify the full-service resolver servers (the primary servers 200, 300 and the secondary servers 210, 310 shown in FIG. 2). The state information indicates whether a full-service resolver server is failed. Specifically, if the state information corresponding to a full-service resolver server is normal, the full-service resolver server is determined to be in a normal state, and if the state information is failed, the full-service resolver server is determined to be failed.

FIG. 5 is an example of the contents of the full-service resolver data 152. The full-service resolver data 152 includes resolver ID data and IP addresses. The resolver ID data and the IP addresses are associated with each other to manage the IP addresses corresponding to the primary servers 200, 300 and the secondary servers 210, 310. When an IP address is changed, the full-service resolver data 152 is updated.

The control unit 160 includes an internal memory for storing programs, which provides various processing procedures, and controlling data to execute various operations therewith. Specifically, in relation to the present invention, the control unit 160 includes an application executing unit 161, a name-resolution processing unit 162, an IP-address converting unit 163, and a full-service resolver monitoring unit 164 as shown in FIG. 3.

The application executing unit 161 executes operations related to various applications. For example, when receiving an access request to contents stored in a web server from the input unit 110, the application executing unit 161 passes information of the requested contents to be accessed to the name-resolution processing unit 162. Upon receiving the information of the requested contents from the application executing unit 161, the name-resolution processing unit 162 generates a DNS packet for requesting a name-resolution corresponding to the requested contents. Then, the name-resolution processing unit 162 refers to the full-service resolver management table 151 to select an IP address of a full-service resolver server with the highest priority, sets the selected IP address as a destination IP address in the DNS packet and passes the DNS packet to the IP-address converting unit 163.

The IP-address converting unit 163 changes the destination IP address in the DNS packet if necessary for preventing the DNS packet from being transmitted to a failed full-service resolver server. Specifically, upon receiving the DNS packet from the name-resolution processing unit 162, the IP-address converting unit 163 refers to the full-service resolver management table 151 to determine whether the full-service resolver server with the highest priority for the destination IP address is failed. When the full-service resolver server with the highest priority is failed, the IP-address converting unit 163 changes the destination IP address to an IP address of a full-service resolver server with the second highest priority and sends the DNS packet to the full-service resolver server with the second highest priority.

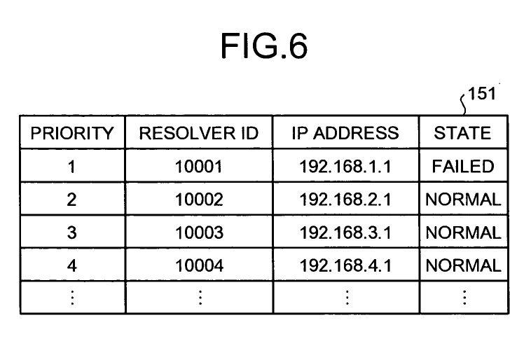

FIG. 6 is another example of the contents of the full-service resolver management table 151 for further explaining the operation of the IP-address converting unit 163. In the example of FIG. 6, it is assumed that a full-service resolver server with the highest priority has the resolver ID 10001, an IP address of 192.168.1.1, and it is failed. Similarly, it is assumed that a full-service resolver server with the second highest priority has the resolver ID 10002, an IP address of 192.168.2.1, and it is normal, and so on. When the destination IP address set in the DNS packet corresponds to the IP address of the full-service resolver server with the resolver ID 10001, because it is failed, the IP-address converting unit 163 changes the destination IP address in the DNS packet to the IP address of the full-service resolver server with the resolver ID 10002. On the contrary, when the full-service resolver server with the resolver ID 10001 is normal, the IP-address converting unit 163 transmits the DNS packet to the full-service resolver server with the resolver ID 10001 without changing the destination IP address.

On the other hand, upon receiving a response of the DNS packet (hereinafter, DNS response packet) from the full-service resolver server, the IP-address converting unit 163 passes the DNS response packet to the name-resolution processing unit 162. However, if the IP-address converting unit 163 has changed the destination IP address in the DNS packet so as to send the DNS packet to the full-service resolver server with the second highest priority when transmitting the DNS packet, and when subsequently receiving the DNS response packet from the full-service resolver server with the second highest priority, the IP-address converting unit 163 changes a source IP address in the DNS response packet so that the source IP address corresponds to the full-service resolver server with the highest priority. After that, the IP-address converting unit 163 passes the DNS response packet to the name-resolution processing unit 162.

Specifically, with reference to FIG. 6, when the IP-address converting unit 163 has changed the destination IP address in the DNS packet from the IP address of the full-service resolver server with the resolver ID 10001 to the IP address of the full-service resolver server with the resolver ID 10002 to transmit the DNS packet to the full-service resolver server with the resolver ID 10002, and subsequently receives the DNS response packet from the full-service resolver server with the resolver ID 10002, the IP-address converting unit 163 changes the source IP address in the DNS response packet so that the source IP address corresponds to the IP address of the full-service resolver server with the resolver ID 10001. After that the IP-address converting unit 163 passes the DNS response packet to the name-resolution processing unit 162.

The full-service resolver monitoring unit 164 regularly attempts to access to the primary servers 200, 300 and the secondary servers 210, 310 so as to monitor normal or failed state of each server. When any one of the primary servers 200, 300 or the secondary servers 210, 310 is failed, the full-service resolver monitoring unit 164 updates the state information in the full-service resolver management table 151 and the full-service resolver data 152. When a full-service resolver server is failed, the full-service resolver monitoring unit 164 updates the state information corresponding to the server from normal to failed. Then, when the failed server is re-activated, the full-service resolver monitoring unit 164 updates again the corresponding state information from failed to normal.

The full-service resolver monitoring unit 164 also conducts a data communication regularly with the primary servers 200, 300 and the secondary servers 210, 310. When an IP address of each of the primary servers 200, 300 or the secondary servers 210, 310 is changed, the full-service resolver monitoring unit 164 updates the corresponding IP address listed in the full-service resolver management table 151 and the full-service resolver data 152. By conducting the data communication, the full-service resolver monitoring unit 164 retrieves information of a load on each full-service resolver server and can change the priority order set in the full-service resolver management table 151 based on the retrieved load information. For example, a full-service resolver server with a lighter load can be changed to be on a higher priority while a full-service resolver server with a higher load can be changed to be on a lower priority. Thus, the priority order of the full-service resolver server can be dynamically changed, thereby effectively performing the operation for the name-resolution.

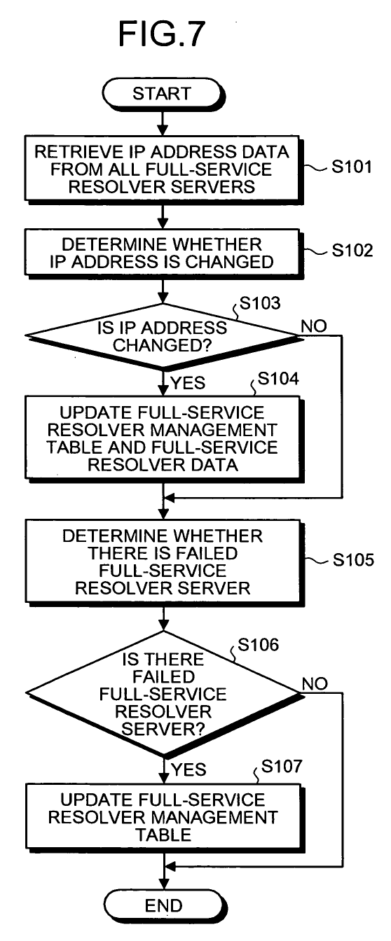

FIG. 7 is a flowchart for explaining an operation performed by the full-service resolver monitoring unit 164 for updating the full-service resolver management table 151 and the full-service resolver data 152. The full-service resolver monitoring unit 164 retrieves IP addresses from each of the full-service resolver servers (the primary servers 200, 300 and the secondary servers 210, 310) (step S101) and determines whether the retrieved IP address is changed by referring to the full-service resolver management table 151 and the full-service resolver data 152 (step S102). When the retrieved IP address is changed (YES at step S103), the full-service resolver monitoring unit 164 updates the IP addresses listed in the full-service resolver management table 151 and the full-service resolver data 152 (step S104). On the contrary, if the retrieved IP address is not changed (NO at step S103), the process control proceeds to step S105.

Subsequently, the full-service resolver monitoring unit 164 determines whether there are any full-service resolver servers that are failed (step S105). When any full-service resolver servers are failed (YES at step S106), the full-service resolver monitoring unit 164 updates the state information in the full-service resolver management table 151 and the full-service resolver data 152 (step S107). On the contrary, if the full-service resolver servers are not failed (NO at step S106), the full-service resolver monitoring unit 164 finishes the operation. Above series of process controls is regularly repeated.

As described above, the full-service resolver monitoring unit 164 monitors the full-service resolver servers and updates the full-service resolver management table 151 and the full-service resolver data 152, thereby accurately determining the information and the state of the full-service resolver server.

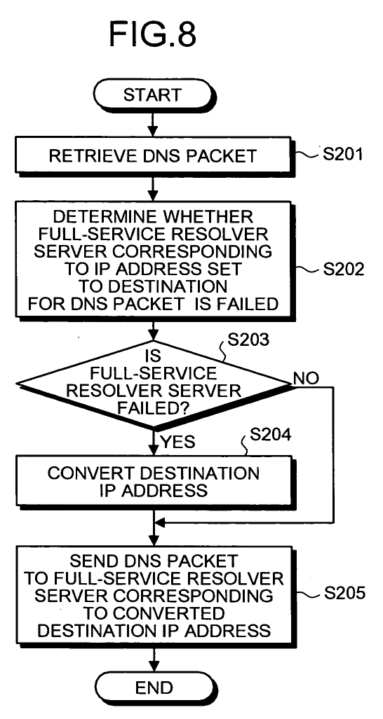

FIG. 8 is a flowchart for explaining a packet-transmitting operation performed by the IP-address converting unit 163. The IP-address converting unit 163 retrieves a DNS packet from the name-resolution processing unit 162 (step S201) and determines whether a full-service resolver server corresponding to the destination IP address set in the DNS packet is failed by referring to the full-service resolver management table 151 (step S202). If the full-service resolver server is failed (YES at step S203), the IP-address converting unit 163 changes the destination IP address to an IP address of the full-service resolver server with the second highest priority (step S204), and transmits the DNS packet to the full-service resolver server with the second highest priority (step S205). On the contrary, if the full-service resolver server is normal (No at step S205), the process control proceeds to step S205.

Thus, when a full-service resolver server corresponding to the destination IP address set in the DNS packet is failed, the IP-address converting unit 163 changes the destination IP address to the alternate IP address so as to directly transmit the DNS packet to a full-service resolver server that is in a normal state, thereby reducing an operation time for the name resolution.

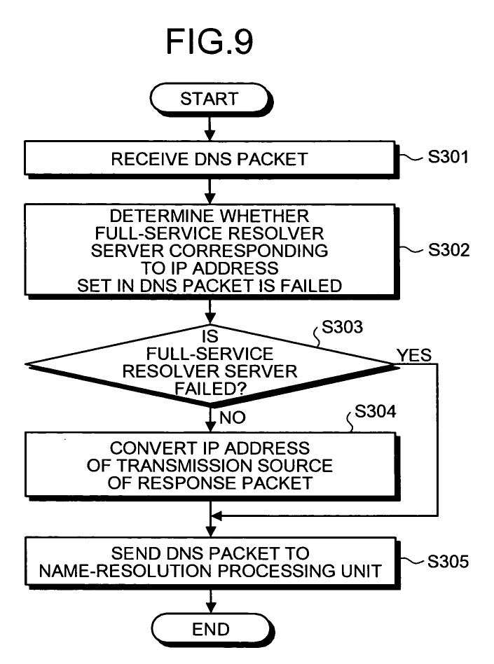

FIG. 9 is a flowchart for explaining a packet-receiving operation performed by the IP-address converting unit 163. The IP-address converting unit 163 receives a DNS response packet from a full-service resolver server (step S301) and determines whether a source IP address set in the DNS response packet corresponds to a full-service resolver server with the highest priority (step S302).

When the source IP address does not correspond to the full-service resolver server with the highest priority (NO at step S303), the IP-address converting unit 163 changes the source IP address to an IP address corresponding to the full-service resolver server with the highest priority (step S304) and passes the DNS response packet to the name-resolution processing unit 162. On the contrary, when the source IP address corresponds to the full-service resolver server with the highest priority (YES at step S303), the process control proceeds to step S305.

Thus, when the source IP address set in the DNS response packet does not correspond to the full-service resolver server with the highest priority, the IP-address converting unit 163 changes the source IP address to the IP address corresponding to the full-service resolver server with the highest priority. As a result, the name-resolution processing unit is not required to perform special processing, thereby reducing costs.

As described above, in the communication terminal apparatus 100 according to the present embodiment, the IP-address converting unit 163 determines whether the full-service resolver server with the highest priority is failed by referring to the full-service resolver management table 151 when receiving a DNS packet from the name-resolution processing unit 162. Then, when the full-service resolver server with the highest priority is failed, the IP-address converting unit 163 changes the destination IP address to the IP address of the full-service resolver server with the second highest priority so that the DNS packet can be transmitted directly to the full-service resolver server with the second highest priority, thereby reducing operation time for the name resolution. Furthermore, the communication terminal apparatus does not transmit unnecessary DNS packet over the network, thereby reducing traffic volume of the network.

Furthermore, according to the present embodiment, when receiving the DNS response packet from the full-service resolver server, the IP-address converting unit 163 changes the source IP address set in the DNS response packet to the IP address of the full-service resolver server with the highest priority. As a result, the name resolution processing unit 162 is not required to perform special processing, thereby reducing costs related to the communication terminal apparatus 100.

Moreover, according to the present embodiment, although the communication terminal apparatus 100 changes the destination IP address in the DNS packet based on the state information with respect to each full-service resolver server when transmitting the DNS packet, other apparatuses can also employ above functions. For example, the present invention can be applied to the full-service resolver server when the full-service resolver server transmits the DNS packet to the DNS servers. Namely, when a DNS server with the highest priority is failed, the full-service resolver server can change a destination IP address in a DNS packet to an IP address of a DNS server with the second highest priority to transmit the DNS packet to the DNS server with the second highest priority.

Each operations described in the above embodiment can be realized by executing programs related to IP conversion processes corresponding to the communication terminal apparatus 100 on a computer terminal.

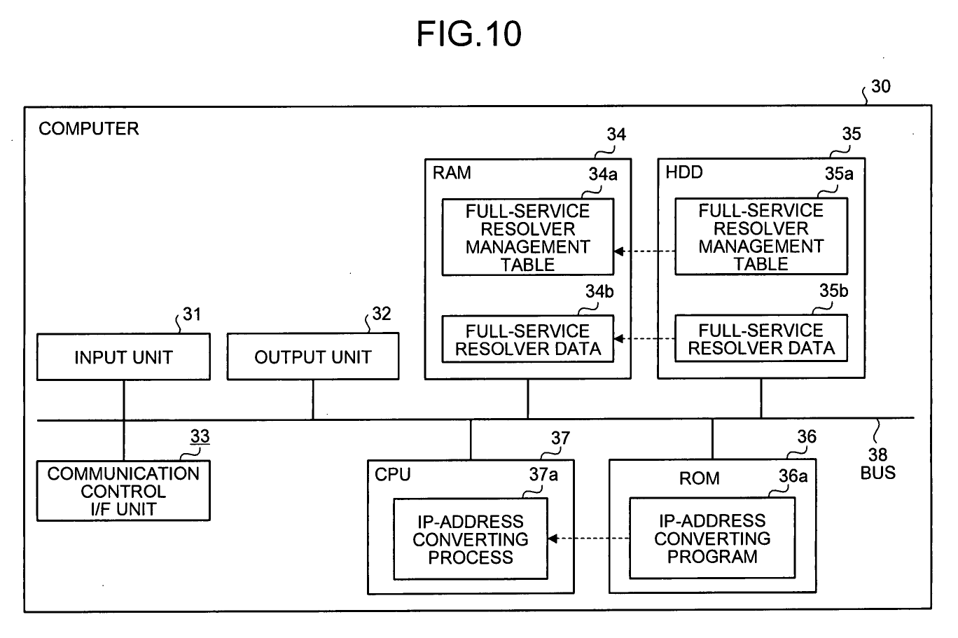

FIG. 10 is a block diagram of a computer terminal 30 that realizes the processes according to the present embodiment. The computer terminal 30 includes an input unit 31, an output unit 32, a communication control interface (I/F) unit 33, a random access memory (RAM) 34, a hard disk drive (HDD) 35, a read only memory (ROM) 36, a central processing unit (CPU) 37, all of which are connected with each other via a bus 38. The input unit 31, the output unit 32, and the communication control I/F unit 33 correspond with respect to each of the input unit 110, the output unit 120 and the communication control I/F unit 130 shown in FIG. 3.

The RAM 34 is a storing unit that stores a full-service resolver management table 34a and full-service resolver data 34b. The full-service resolver management table 34a and the full-service resolver data 34b correspond to the full-service resolver management table 151 and the full-service resolver data 152 shown in FIG. 3, respectively. A full-service resolver management table 35a and full-service resolver data 35b are prepared in the HDD 35 and retrieved by the RAM 34 when executed. The ROM 36 stores IP conversion processing programs that perform functions corresponding to the communication terminal apparatus 100. Namely, the ROM 36 stores an IP-address converting program 36a as shown in FIG. 10. The CPU 37 reads out the IP-address converting program 36a from the ROM 36 to execute. When executed by the CPU 37, the IP-address converting program 36a functions as an IP-address converting process 37a. Then, the CPU 37 changes the destination IP address in the DNS packet by using various data stored in the RAM 34.

According to an embodiment of the present invention, when the communication terminal apparatus monitors state of a pair of servers, which are provided redundantly with each other and used for the name resolution, determines whether a server with the highest priority is normal or failed, and if the server is failed, the communication terminal apparatus changes the destination IP address in the DNS packet to an IP address of a server with the second highest priority. As a result, the communication terminal apparatus can directly send the DNS packet to the server with the second highest priority without attempting to send the DNS packet to the server with the highest priority, thereby reducing an operation time for the name resolution.

Furthermore, according to an embodiment of the present invention, when receiving the DNS response packet from the server with the second highest priority, the communication terminal apparatus changes the source IP address set in the DNS response packet to the IP address of the server with the highest priority, so that the name-resolution processing unit is not required to perform special processing, thereby reducing costs.

Moreover, according to an embodiment of the present invention, the communication terminal apparatus monitors state of the pair of servers, stores state information of the serves, and determines whether the servers are normal or failed based on the state information, thereby accurately performing operations related to the name resolution.

Although the invention has been described with respect tog a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmission control apparatus that controls transmission of a packet requesting a name resolution, the transmission control apparatus comprising:
a determining unit that monitors a state of a server that performs the name resolution, and determines whether there is a failure in a first server; and
a transmission control unit that converts, when the determining unit determines that there is a failure in the first server, a destination address set in the packet into a destination address of a second server, and transmits the packet to the second server.

2. The transmission control apparatus according to claim 1, further comprising:
a converting unit that converts, upon receiving a response to the packet from the second server, identification information of the second server into identification information of the first server in which the failure has occurred.

3. The transmission control apparatus according to claim 1, further comprising:
a recording unit that monitors the state of the server that performs the name resolution, and records information on the state of the server as state information of the server, wherein
the determining unit determines whether there is a failure in the first server based on the recorded state information.

4. The transmission control apparatus according to claim 1, wherein
the transmission control unit acquires information on a load on the server that performs the name resolution, and selects a server that is normally operating with lightest load as the second server.

5. A method of controlling transmission of a packet requesting a name resolution, the method comprising:
failure determining including
monitoring a state of a server that performs the name resolution; and
determining whether there is a failure in a first server; and
transmission controlling including
converting, when it is determined that there is a failure in the first server at the determining, a destination address set in the packet into a destination address of a second server; and
transmitting the packet to the second server.

6. The method according to claim 5, further comprising:
converting, when a response to the packet is received from the second server, identification information of the second server into identification information of the first server in which the failure has occurred.

7. The method according to claim 5, further comprising:
recording including
monitoring the state of the server that performs the name resolution; and
recording information on the state of the server as state information of the server, wherein
the determining includes determining whether there is a failure in the first server based on the recorded state information.

8. The method according to claim 5, wherein
the transmission controlling further includes
acquiring information on a load on the server that performs the name resolution; and
selecting a server that is normally operating with lightest load as the second server.

9. A computer-readable recording medium that stores therein a computer program for controlling transmission of a packet requesting a name resolution, wherein
the computer program causes a computer to execute:
failure determining including
monitoring a state of a server that performs the name resolution; and
determining whether there is a failure in a first server; and
transmission controlling including
converting, when it is determined that there is a failure in the first server at the determining, a destination address set in the packet into a destination address of a second server; and
transmitting the packet to the second server.

10. The computer-readable recording medium according to claim 9, wherein
the computer program further causes the computer to execute converting, when a response to the packet is received from the second server, identification information of the second server into identification information of the first server in which the failure has occurred.

11. The computer-readable recording medium according to claim 9, wherein
the computer program further causes the computer to execute recording including
monitoring the state of the server that performs the name resolution; and
recording information on the state of the server as state information of the server, and
the determining includes determining whether there is a failure in the first server based on the recorded state information.

12. The computer-readable recording medium according to claim 9, wherein
the transmission controlling further includes
acquiring information on a load on the server that performs the name resolution; and
selecting a server that is normally operating with lightest load as the second server.
